(19) United States
(12) Patent Application Publication
(10) Pub. No.: US 2006/0141281 A1
(43) Pub. Date: Jun. 29, 2006

(54) R-T-B system permanent magnet and plating film

(75) Inventors: Yasuyuki Nakayama, Tokyo (JP); Kazuhito Yamasawa, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK CORPORATION

(21) Appl. No.: 11/317,550

(22) Filed: Dec. 22, 2005

(30) Foreign Application Priority Data
Dec. 24, 2004 (JP) 2004-373522
Dec. 24, 2004 (JP) 2004-373523

(51) Int. Cl. B32B 15/04; B32B 15/00; B32B 15/01; B32B 19/00; B32B 9/04

(52) U.S. Cl. 428/627; 428/699; 428/702; 428/704; 428/457; 428/668; 428/680

(57) ABSTRACT

It is an object of the present invention to provide an R—T—B system permanent magnet which is easy to apply in the production of an actual R—T—B system permanent magnet, and which contains a plating film that is also effective in securing hardness. The present invention achieves this object by providing an R—T—B system permanent magnet 1 which contains a magnet base body 2 constituted from a sintered body which contains at least main phase grains containing an R₂T₁₄B compound, and a grain boundary phase which contains a larger amount of R than the main phase grains, and a plating film 3 which covers the magnet base body 2 surface and which contains, when C content is defined as Cc (wt. %), 0.005<Cc≦0.2 wt. %.

### BACKGROUND OF THE INVENTION

1. Field of the Invention

The present invention relates to an R—T—B system permanent magnet formed with a plating film on its surface, and a plating film.

2. Description of the Related Art

R—T—B system permanent magnets which have a main phase of an R₂T₁₄B type intermetallic compound have excellent magnetic properties. Further, their main composition is Nd, which is abundant as a natural resource and is relatively inexpensive. These factors mean that R—T—B system permanent magnets are used in a variety of electric devices. Herein, R represents one or more rare earth elements, which includes Y, and T represents one or more transition metal elements essentially comprising Fe, or Fe and Co.

Even for R—T—B system permanent magnets which have excellent magnetic properties, some technical problems exist. One of these is corrosion resistance. That is, the main constituents of an R—T—B system permanent magnet are R and Fe, which are susceptible to oxidation, so that the corrosion resistance of such a magnet is poor. For this reason, a protective film for preventing corrosion is formed on the magnet surface. Protective films which can be employed include resin coating, a chromate coat, plating-or the like. However, a method which forms a plating film, as represented especially by Ni(nickel) plating, Cu(copper)plating or Sn (tin) plating, on the surface provides excellent corrosion resistance and abrasion resistance, and is thus widely used.

Some proposals have been made to improve the corrosion resistance of a plating film formed on the surface of an R—T—B system permanent magnet. For example, Japanese Patent No. 2941446 (Patent Document 1) discloses improving corrosion resistance by providing a Ni plating layer comprising between 0.001 and 0.01 wt. % of S (sulfur) as an underlayer, providing a Ni plating comprising between 0.001 and 1.0 wt. % of S (sulfur) as an upper layer, and incorporating more S in the upper layer than in the underlayer by 0.01 wt.% or more. Patent Document 1 illustrates that by providing a bilayer Ni plating layer having the above-described S content relationship, an anode effect is generated as a result of the upper layer being anodized, whereby the underlayer is protected from corrosion.

[Patent Document 1]: Japanese Patent No. 2941446

According to Patent Document 1, an R—T—B system permanent magnet can be conferred with improved corrosion resistance. However, investigations carried out by the present inventors showed that it is not easy to control S content in a plating film. The S contained in the plating film is mainly derived from a brightener added in the plating bath. However, it is difficult to freely set the amount of S contained in the plating film if the type of brightener is specified. Therefore, it must be said that a method to improve corrosion resistance by controlling the S content in the plating film is not very versatile for producing an actual R—T—B system permanent magnet.

Another characteristic required for a plating film is hardness. This is because considerable amount of stress may be placed on the plating film surface and abrasion resistance against the surrounding environment maybe required, depending on the production steps or intended use of the R—T—B system permanent magnet. However, no effective methods have yet been proposed for improving the hardness of a plating film. In particular, the present inventors have found no proposals for improving hardness in view of corrosion resistance, which is the essential characteristic required for a plating film.

The present invention was created in view of these technical problems, and it is an object of the present invention to provide a plating film, which is easy to apply in the production of an actual R—T—B system permanent magnet, and which is effective in securing hardness, and an R—T—B system permanent magnet comprising the plating film.

### SUMMARY OF THE INVENTION

The present inventors have confirmed that C (carbon) is an element whose content in a plating film can be easily controlled to improve corrosion resistance of the film and which is effective for improving the hardness of a plating film. The present inventors further found that by incorporating a certain amount of C in a plating film, plating film adhesion could be improved. That is, the present invention is directed to an R—T—B system permanent magnet comprising a magnet base body and a plating layer which covers the magnet base body surface and which comprises, when C content is defined as Cc, 0.005<Cc≦0.2 wt. %. The magnet base body is constituted from a sintered body which comprises at least main phase grains consisting of an R₂T₁₄B compound, and a grain boundary phase which comprises a larger amount of R than the main phase grains. In the present invention, R represents one or more rare earth elements including Y, and T represents one or more transition metal elements comprising Fe, or Fe and Co as essential components.

In the present invention, the plating film C content Cc is preferably 0.006≦Cc≦0.18 wt. %, and more preferably 0.007≦Cc≦0.15 wt. %. Further, the plating film preferably comprises an electrolytic plating film of Ni or an electrolytic plating film of Cu.

In some cases, the plating film of the R—T—B system permanent magnet is constituted from a plurality of plating layers. In such a case, the present inventors discovered that the difference in C content between the respective layers has an effect on corrosion resistance. That is, when the plating film comprises a first plating layer provided on a magnet base body surface side and a second plating layer provided on the first plating layer, it is effective for improving corrosion resistance to set the difference in C content between the first plating layer and the second plating layer to be 0.1 wt. % or less. The first plating layer and the second plating layer are preferably electrolytic plating of Ni and/or Cu.

The plating layer according to the present invention is not limited to being formed on the surface of an R—T—B system permanent magnet. It can be used covering any kind of other component to improve corrosion resistance. Accordingly, the present invention provides a plating film which covers over a substrate for corrosion resistance improvement, and which comprises 0.005<Cc≦0.2 wt. %. In this case too, when the plating film comprises a first plating layer provided on the substrate side and a second plating layer provided on the first plating layer, the difference in C content between the first plating layer and the second plating layer is preferably 0.1 wt. % or less.

According to the present invention, plating film corrosion resistance can be secured by using C, whose content can be easily controlled, in the plating film. Further, incorporating a certain amount of C in the plating film improves the hardness of the plating film and improves adhesion to the magnet base body. In particular, as in the present invention, such effects are remarkable as a result of providing the plating film with a plurality of layers having different C content.

### BRIEF DESCRIPTION OF THE DRAWINGS

FIG. 1 is a view illustrating an R—T—B system permanent magnet which comprises a plating film;

FIG. 2 is view illustrating another example of an R—T—B system permanent magnet which comprises a plating film;

FIG. 3 is view illustrating another example of an R—T—B system permanent magnet which comprises-a plating film;

FIG. 4 is a table showing the deposit conditions and the evaluated results of the plating films in Example 1;

FIG. 5 is a graph showing the relationship between plating film C content and plating film hardness in Example 1;

FIG. 6 is a graph showing the relationship between plating film C content and plating film adhesion in Example 1;

FIG. 7 is a table showing the deposit conditions and the evaluated results of the plating films in Example 2;

FIG. 8 is a graph showing the relationship between plating film C content and plating film hardness in Example 2;

FIG. 9 is a graph showing the relationship between plating film C content and plating film adhesion in Example 2;

FIG. 10 is a table showing the deposit conditions of the plating films in Example 3; and

FIG. 11 is a table showing the evaluated results of the plating films in Example 3.

FIG. 12 is a table showing the deposit conditions of the plating films in Example 4; and

FIG. 13 is a table showing the evaluated results of the plating films in Example 4.

### DETAILED DESCRIPTION OF THE PREFERRED EMBODIMENTS

The present invention will now be described in more detail with reference to the embodiments illustrated in the attached drawings.

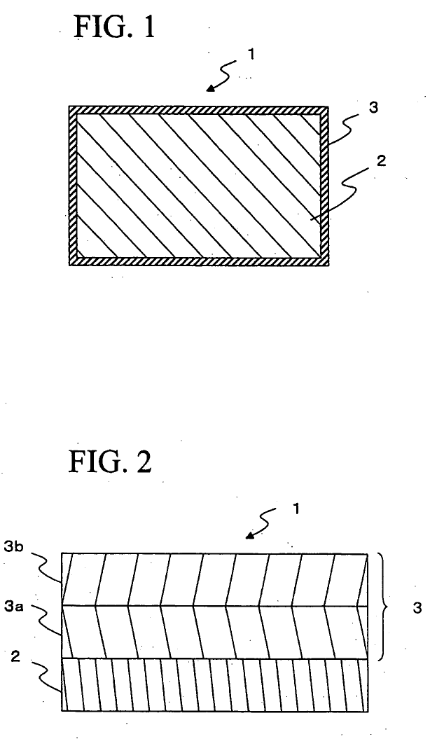

As illustrated in FIG. 1, the R—T—B system permanent magnet 1 according to the present invention comprises a magnet base body 2 and a plating film 3 covering the surface of the magnet base body 2. The characteristic of the present invention lies in this plating film 3. By incorporating into this plating film 3 at 0.005<Cc≦0.2 wt. % of C, the plating film 3 can be conferred with excellent corrosion resistance. A plating film 3 which comprises such an amount of C not only has an effect which improves hardness, but can also improve adhesion of the plating film 3 to the magnet base body 2. If the C content is merely 0.005 wt. % or less (including zero), the above-described effects cannot be achieved. On the other hand, if the C content exceeds 0.2 wt. %, cracks appear in the plating film 3, and corrosion resistance cannot be secured. Therefore, the present invention sets the C content contained in the plating film 3 to 0.005<Cc≦0.2 wt. %. A preferable C content incorporated into the plating film 3 is 0.006≦Cc≦0.18 wt. %, and more preferably 0.007≦Cc≦0.15 wt. %.

It is unclear why a plating film 3 comprising 0.005<Cc≦0.2 wt. % of C is not only effective in improving corrosion resistance, but also improves adhesion with the magnet base body 2 as well as improving hardness. However, the C which is incorporated into the plating film 3 is effective in suppressing the growth of the microstructure constituting the plating film 3, especially growth towards the surface direction. For this reason the microstructure of the plating film 3 is fine structurized and densified, from which it is inferred that corrosion resistance and adhesion improve. In the same fashion, it is also inferred that the fine structurization of the microstructure aids in improving hardness.

The C contained in the plating film 3 may exist uniformly throughout the entire plating film 3, or may vary. If the C content in the plating film 3 does vary, it should be set within a range of 0.005<Cc≦0.2 wt. % across the entire area.

As illustrated in FIG. 2, in the present invention, when the plating film 3 comprises a first plating layer 3a provided on a magnet base body 2 side and a second plating layer 3b provided on the first plating layer 3a, making the difference in C content between the first plating layer 3a and the second plating layer 3b to be no greater than 0.1 wt. % contributes to improving corrosion resistance. While it is not clear why corrosion resistance deteriorates if the difference in C content between the first plating layer 3a and the second plating layer 3b exceeds 0.1 wt. %, it is thought that a difference in grain size between the first plating layer 3a and the second plating layer 3b occurs as a result of their different C content, causing inconsistencies in the boundary vicinity, whereby corrosion resistance deteriorates. The difference in C content between the first plating layer 3a and the second plating layer 3b is more preferably no greater than 0.08 wt. %.

The C contained in the first plating layer 3a and the second plating layer 3b may exist uniformly throughout the entire first plating layer 3a and the second plating layer 3b, or it may vary.

Although the present invention does not limit the metals which constitute the plating film 3, the plating film 3 preferably comprises any of Ni, Cu or Sn. This is because when Ni, Cu or Sn constitutes the plating film 3 of the R—T—B system permanent magnet 1, excellent corrosion resistance is achieved obviously, by applying the present invention, an even greater improvement in corrosion resistance is accomplished.

The plating film 3 can be constituted from a single metal. For example, the plating film 3 can be constituted from just Ni plating, Cu plating or Sn plating.

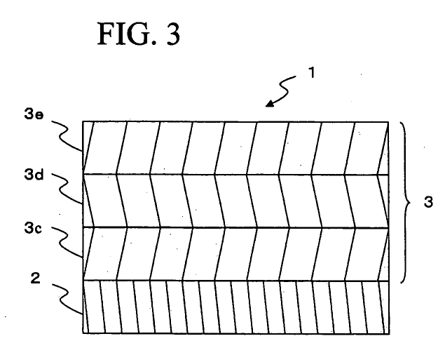

The plating film 3 can also be constituted by laminating many kinds of metal. For example, as in the embodiment illustrated in FIG. 2, the plating film 3 can be constituted by sequentially laminating from the magnet base body 2 side, Cu plating 3a and Ni plating 3b. Alternatively, as in the embodiment illustrated in FIG. 3 for example, the plating film 3 can be constituted from 3 layers by sequentially laminating from the magnet base body 2 side, Cu plating 3c, Ni plating 3d and Sn plating 3e. In this case, concerning the Cu plating 3c and Ni plating 3d, the Cu plating 3c becomes the first plating layer and the Ni plating 3d becomes the second plating layer. Further, concerning the Ni plating 3d and the Sn plating 3e, the Ni plating 3d becomes the first plating layer and the Sn plating 3e becomes the second plating layer.

Further, the plating film 3 can be constituted by multi-layering with the same kind of metal. For example, after forming a first layer (first plating layer) of Ni plating on the magnet base body 2, Ni plating (second plating layer) can be further laminated thereon. If the plating film 3 is multi-layered, the nit is particularly preferable to form with multiple layers of Ni plating. The number of laminated layers is not restricted to two or three layers, and can be four layers or more.

In the present invention, when the plating film 3 is multi-layered (2 or more layers), if the C content of each plating layer is defined as Cc, the content must be in the range of 0.005<Cc≦0.2 wt. %. Further, the difference in C content between two layers in direct contact is no greater than 0.1 wt. %, and preferably no greater than 0.08 wt. %.

It does not matter what method is employed to set the C content in the plating film 3 to be in the range of 0.005<Cc≦0.2 wt. % as prescribed in the present invention, nor does it matter what method is employed for setting the difference in C content between the first plating layer 3a and the second plating layer 3b to be no greater than 0.1 wt. %. The C content in the plating film 3 can, however, be controlled by adjusting the below factors.

The C content in the plating film 3 can be varied by changing the number of C—C bonds in the plating bath. Specifically, the C content in the plating film 3 can be controlled by changing the kind of organic functional groups in the plating bath. For example, by changing the HCHO, which is a type of semi-brightener containable in plating baths, to CH₃CHO or even C₂H₅CHO, the C content in the plating film 3 can be changed. The C content in the plating film 3 can also be changed by changing the concentration of the brightener containable in the plating bath. Examples of brighteners which can be used include sulfonates, such as sodium 1,5-naphthalenedisulfonate and sodium 1,3,6-naphthalenetrisulfonate, para-toluene sulfonamide, saccharin, formaldehyde, 1,4-butynediol, propargyl alcohol, ethylene cyanhydrin and the like.

Another method for controlling the C content in the plating film 3 is to vary the current density applied to the plating bath during the plating step. While the C content varies depending on the additives added into the plating bath, generally the C content in the plating film 3 increases for a larger current density. Therefore, if the C content in the plating film 3 needs to be increased, this can be achieved by increasing the current density in the plating bath during the plating step. Conversely, if the C content in the plating film 3 needs to be decreased, this can be achieved by decreasing the current density in the plating bath during the plating step.

The thickness of the plating film 3 is preferably set in the range of 1 to 30 μm. If the thickness is less than 1 μm, adequate corrosion resistance cannot be attained even if the present invention is utilized. On the other hand, if the thickness exceeds 30 μm, not only are the corrosion resistance effects saturated, but magnetic properties per unit volume decrease, due to the drop in volume that the magnet base body 2 occupies in the R—T—B system permanent magnet 1. This decrease in magnetic properties becomes more marked the smaller the R—T—B system permanent magnet 1 becomes. A preferable plating film 3 thickness is from 5 to 25 μm. If the plating film 3 is constituted from a plurality of layers, the above-described range is the sum of the plural layers.

Next, the magnet base body 2 will be explained. If an R—T—B system permanent magnet is used as the magnet base body 2, the effects of the present invention are remarkable. This is because, as described above, corrosion resistance of an R—T—B system permanent magnet is poor. A preferable chemical composition for the R—T—B system permanent magnet will now be described.

The R—T—B system permanent magnet comprises 27.0 to 35.0 wt. % of a rare earth element (R). Here, the term “rare earth element” is a concept which includes Y. Accordingly, R according to the present invention is one or more rare earth elements selected from the group consisting of La, Ce, Pr, Nd, Sm, Eu, Gd, Tb, Dy, Ho, Er, Yb, Lu and Y. If the amount of the rare earth element in the magnet base body 2 is less than 27.0 wt. %, α-Fe or the like having soft magnetism segregates, and the coercive force thereby significantly decreases. In addition, less than 27.0 wt. % causes the sinterabilities to deteriorate. On the other hand, if the amount exceeds 35.0 wt. %, not only does corrosion resistance deteriorate due the amount of R-rich phase increasing, but the volume ratio of the R₂T₁₄B grains as a main phase decreases, and the residual magnetic flux density also decreases. Therefore, the amount of the rare earth element is set between 27.0% and 35.0 wt. %. A preferable amount is between 28.0% and 33.0 wt. %, and a more preferable amount is between 29.0% and 31.0 wt. %.

Among R, Nd and Pr are preferable to use as the main component for the rare earth element because Nd and Pr possess the best balance in magnetic properties, are abundant as a natural resource and are relatively inexpensive. Moreover, Dy and Tb have a large anisotropic magnetic field, and are effective in improving coercive force. Accordingly, it is preferable to select as a main component Nd and/or Pr, and Dy and/or Tb, wherein the total of Nd and/or Pr amount and Dy and/or Tb amount is set between 27.0% and 35.0 wt. %.

TheR—T—Bsystem permanentmagnetconstitutingthe magnet base body 2 comprises 0.5% to 2.0 wt. % of boron (B). If the amount of B is less than 0.5 wt. %, a high coercive force cannot be obtained. However, if the amount of B exceeds 2.0 wt. %, the residual magnetic flux density is likely to decrease. Accordingly, the upper limit is set at 2.0 wt. %. The amount of B is preferably between 0.5 wt. % and 1.5 wt. %, and more preferably between 0.9 wt. % and 1.1 wt. %.

The R—T—B system permanent magnet constituting the magnet base body 2 may comprise one or more of 0.1 to 2.0 wt. % of Nb, 0.05 to 0.25 wt. % of Zr, 0.02 to 2.0 wt. % of Al, 0.3 to 5.0 wt. % of Co, and 0.01 to 1.0 wt. % of Cu. These are positioned as elements for substituting part of the Fe.

The present invention may also comprise elements other than those mentioned above. For example, the present invention preferably comprises as appropriate Ga, Bi and Sn. Ga, Bi and Sn have an effect in improving coercive force and coercive force temperature characteristics. However, because excessive addition of these elements also triggers a drop in residual magnetic flux, the amount is preferably set between 0.02 to 0.2 wt. %. Further, one or more elements selected from the group consisting of Ti, V, Cr, Mn, Ta, Mo, W, Sb, Ge, Ni, Si and Hf may also be incorporated.

Next, a method for manufacturing the magnet base body 2 will be explained.

An R—T—B system permanent magnet constituting the magnet base body 2 is, as is well known, constituted from a sintered body which comprises at least R₂T₁₄B grains as a main phase and a grain boundary phase which comprises a larger amount of R than the main phase. A preferable manufacturing method to obtain such a sintered body will now be explained.

The raw material alloy can be manufactured by strip casting or some other well-known melting method in a vacuum or an inert gas atmosphere, preferably an Ar atmosphere. This also applies for manufacturing an R—T—B system permanent magnet according to the present invention by a so-called mixing method using an alloy (low R alloy) whose main constituent is R₂T₁₄B grains and an alloy (high R alloy) which comprises a larger amount of R than the low R alloy.

The raw material alloy is supplied to a milling step. When employing a mixing method, the low R alloy and high R alloy may be milled separately or together. The milling step comprises a crushing step and a pulverizing step. First, the raw material alloy is crushed to a particle size of approximately several hundreds micrometers. The crushing is preferably carried out in an inert gas atmosphere, using a stamp mill, a jaw crusher, a brown mill or the like. Prior to the crushing, it is effective to carry out milling by occluding hydrogen into the raw material alloy and then releasing it. Mechanical crushing can be omitted by regarding this hydrogen milling as the crushing.

The crushing step is followed by a pulverizing step. A jet mill is mainly used in the pulverizing, wherein crushed powder with a particle size of approximately several hundreds micrometers is pulverized to a mean particle size of between 2 to 10 μm, and preferably between 3 to 8 μm. A jet mill is a method which generates a high-speed gas flow by releasing a high-pressure inert gas from a narrow nozzle. The crushed powder is accelerated by this high-speed gas flow, causing crushed powder particles to collide with each other, a target, or the container wall, whereby the powder is pulverized.

When using a mixing method, the timing for mixing the two alloys is not limited. However, if the low R alloy and the high R alloy are pulverized separately in the pulverizing step, the pulverized low R alloy powder is preferably mixed with the pulverized high R alloy powder in an inert gas atmosphere. The mixing ratio of the low R alloy powder and the high R alloy powder may be set approximately between 80:20 and 97:3 by weight ratio. The mixing ratio for when the low R alloy is pulverized together with the high R alloy is the same. A fine powder highly oriented can be obtained when compacted in the following compacting step in a magnetic field by adding approximately 0.01% to 0.3 wt. % of a milling aid such as zinc stearate during the pulverizing step.

The fine powder obtained in this manner is fed into a mold and compacted in a magnetic field. The compacting in a magnetic field can be carried out in a magnetic field of around 960 to 1,600 kA/m (12 to 20 kOe) at a pressure of about 68.6 to 147 MPa (0.7 to 1.5 t/cm²).

Subsequent to the compacting in a magnetic field, the compacted body is sintered in a vacuum or an inert gas atmosphere. While the sintering temperature needs to be adjusted depending on various conditions such as a composition, milling method, difference in mean particle size and particle size distribution, the sintering may be carried out at 1,000° C. (degree C.) to 1,100° C. for about 1 to 10 hours. A step for removing the milling aid, gases and other substances which were contained in the compacted body prior to the sintering step may also be carried out. After completion of the sintering, the obtained sintered body may be subjected to an aging treatment. This step is important for controlling coercive force. If the aging treatment is carried out in two stages, it is effective to retain the sintered body for prescribed lengths of time at around 800° C. and around 600° C. Carrying out the heat treatment at around 800° C. after the sintering is especially effective in the mixing method, as the coercive force increases. Moreover, coercive force dramatically increases by carrying out the heat treatment at around 600° C. Thus, when the aging treatment is carried out in a single stage, it is preferable to carry out an aging treatment at around 600° C.

Once a sintered body has been obtained, a plating film 3 is formed. The plating film 3 according to the present invention can be formed by either electrolytic or non-electrolytic plating, although it is more preferable to form using electrolytic plating because C content control is simple. If carrying out electrolytic plating, the sintered body is subjected to a treatment prior to carrying out the electrolytic plating (pretreatment). After the sintered body has been formed into a certain shape with certain accuracy, this pretreatment subjects the sintered body to, for example, barrel polishing, degreasing, washing, etching (e.g. nitric acid) and washing. This process is just one example, and should not be taken as a matter which limits the present invention. Next, the plating film 3 is deposited by electrolytic plating. Once the plating film 3 has been deposited, the plating film 3 is washed and dried, whereby the series of processes for forming the plating film 3 by electrolytic plating is completed.

Deposition of the plating film 3 will be further explained.

As the plating film 3, the below-described methods can be applied as typical plating conditions for when an electrolytic nickel plating film is formed. The below is just an example, and is not a matter which limits the present invention.

(1) Plating Bath: Nickel Sulfate, Ammonium Chloride and Boric Acid

pH: 5.6 to 5.8

Temperature: 20 to 30° C.

Current density: 0.5 to 5 A/dm²

(2) Plating Bath (Watts Bath): Nickel Sulfate, Nickel Chloride and Boric Acid

pH: 4.5 to 5.5

Temperature: 40 to 60° C.

Current density: 1 to 7 A/dm²

(3) Plating Bath: Nickel Sulfamate, Nickel Bromide and Boric Acid

pH: 4.0 to 5.0

Temperature: 40 to 50° C.

Current density: 1 to 15 A/dm²

As the plating film 3, the below-described methods can be applied as typical plating conditions for when an electrolytic copper plating film is formed. The below is just an example, and is not a matter which limits the present invention.

(1) Plating bath: Copper Pyrophosphate Trihydrate, Potassium Pyrophosphate and Ammonia

pH: 8 to 10

Temperature: 50 to 60° C.

Current density: 2 to 6 A/dm²

(2) Plating Bath: Copper Salt, Phosphate, an Aliphatic Phosphonic Acid Compound and a Metal Hydroxide

pH: 9.5 to 10.5

Temperature: 55 to 65° C.

Current density: 1 to 10 A/dm²

If an electrolytic tin plating film is formed as the plating film 3, any of a Ferrostan method, a halogen method or an alkali method can be used. The Ferrostan and halogen methods are plating methods which employ an acidic bath, wherein Sn precipitates from Sn²⁺. In the Ferrostan method tin phenolsulfonate is used, while in the halogen method stannous chloride is used. In the alkali method sodium stannate serves as the main constituent, wherein Sn precipitates from Sn²⁺.

In the above, an example in which a plating film 3 according to the present invention was applied to an R—T—B system permanent magnet was explained. However, the plating film 3 according to the present invention is not limited to applications as a protective film for an R—T—B system permanent magnet. It goes without saying that the plating film 3 according to the present invention can be applied to other rare earth magnets which require corrosion resistance, as well as a protective film for other components which require corrosion resistance.

### EXAMPLE 1

A strip-shaped alloy having a certain composition was manufactured by a strip casting method. This strip-shaped alloy was made to occlude hydrogen at room temperature. The temperature was raised to about 400 to 700° C. in an Ar atmosphere, and a coarse powder was obtained by dehydrogenation.

This coarse powder was subjected to pulverizing using a jet mill. The pulverizing was conducted by purging the jet mill interior with N₂ gas and then using a high-pressure N₂ gas flow. The mean particle size of the obtained fine powder was 4.0 μm. It is noted that prior to carrying out the pulverizing, 0.01 to 0.10 wt. % of zinc stearate was added as a milling aid.

The obtained fine powder was compacted in a 1,200 kA/m (15 kOe) magnetic field at a pressure of 98 MPa (1.0 ton/cm²), to thereby yield a compacted body. This compacted body was sintered in a vacuum for 4 hours at 1,030° C., and then quenched. The obtained sintered body was subsequently subjected to a two-stage aging treatment consisting of treatments of 850° C. for 1 hour and 540° C. for 1 hour (both in an Ar atmosphere). Analysis of the sintered body showed that it had a composition consisting of 26.5 wt. % of Nd, 5.9 wt. % of Dy, 0.25 wt. % of Al, 0.5 wt. % of Co, 0.07 wt. % of Cu, 1.0 wt. % of B and balance of Fe.

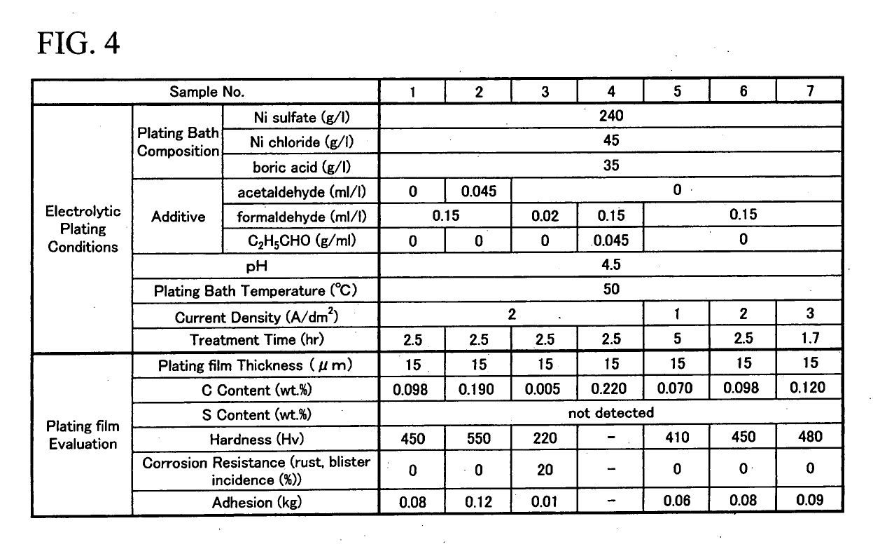

The obtained R—T—B system permanent magnet was cut into samples having a size of 30 mm×40 mm×5 mm. The samples were barrel polished, and then subjected to alkali degreasing, nitric acid washing and alkali ultrasonic washing. The samples were dried, after which Ni plating was applied onto the surface of the samples under the conditions shown in FIG. 4. Sample Nos. 1 to 7 were prepared under the condition shown in FIG. 4. It is noted that sample No. 1 is the same as No. 6.

After the Ni plating was completed, the formed plating films were evaluated. The evaluated items and evaluation methods were as illustrated below. It is noted that since cracks appeared in the plating film of sample 4, the below-described evaluations for hardness, corrosion resistance and adhesion were not performed for sample No. 4.

Measurement of the plating film thickness: Film thickness was measured using a fluorescent X-ray coating gauge for microscopic areas thickness. The film thickness testing was carried out on the flat center portion of the samples, and taking the average value of 5 samples that were prepared under the same condition.

Analysis of the plating film composition: Just the plating film was peeled off, and the C and S content were analyzed using a combustion in oxygen flow/infrared absorption.

Hardness (Hv): A Vickers hardness meter was used to measure the Vickers hardness, taking the average value of 5 samples that were prepared under the same condition.

Corrosion resistance: The surface condition (blistering, rust) of samples which had been maintained for 40 hours under conditions of 120° C., 100% RH (Relative Humidity) and 2 atm., was visually observed. The samples were evaluated according to the ratio of the sample number in which blistering or corrosion occurred out of 20 samples that were prepared under the same condition.

Adhesion: Two parallel cuts, having a width of 10 mm, a depth of between 30 to 40 μm and a length of 20 mm, were inserted into the plating film. The pair of 2 cuts were connected to 1 cut of the same depth, and the plating film was peeled away from the cuts in a vertical manner. The force used in peeling away at this time was measured, wherein adhesion was taken as the average value of 5 samples that were prepared under the same condition.

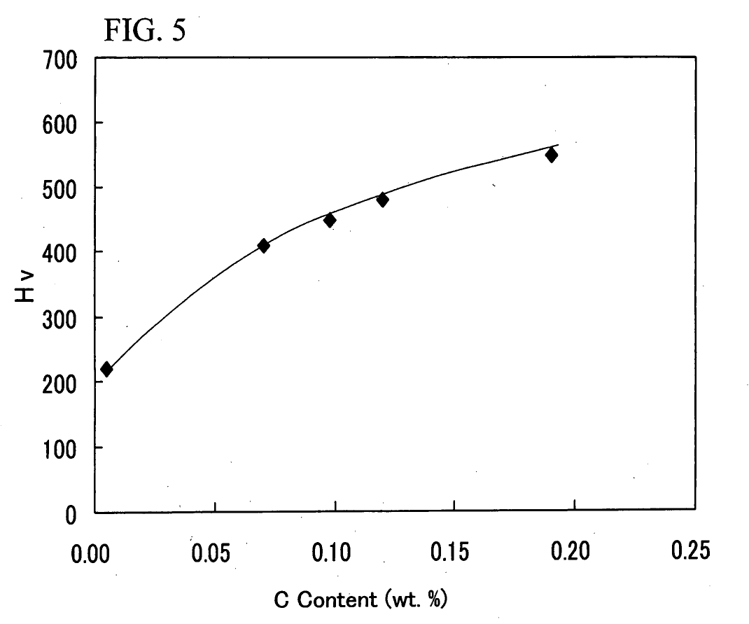

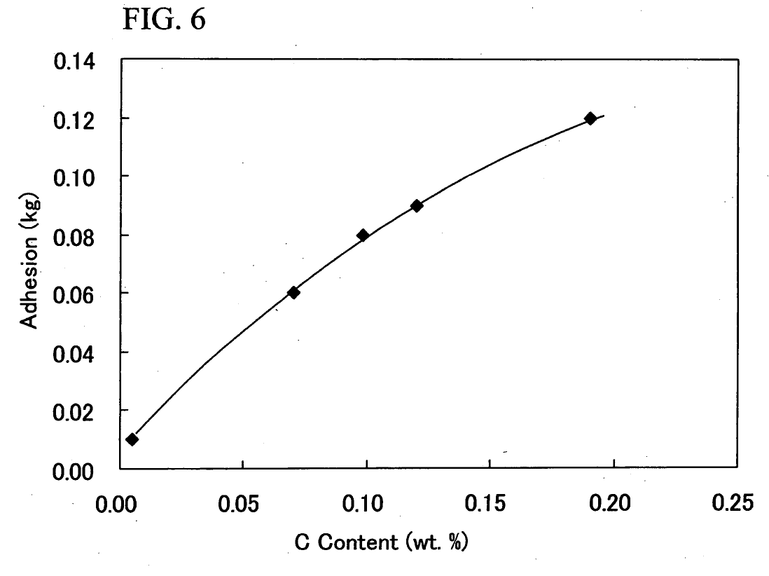

The results for the above measurements are shown in FIG. 4. In addition, the relationship between the plating film C content and the plating film hardness (Hv) is illustrated in FIG. 5, while the relationship between the plating film C content and the plating film adhesion is illustrated in FIG. 6.

Sample No. 3, which had a C content of 0.005 wt. %, had poor plating film adhesion. Sample No. 4, which had a C content of 0.220 wt. % is not goodbecause cracks appeared in the plating film thereof. S (sulfer) did not detected in both of them. Therefore, it was confirmed that C (carbon) as well as S can control the plating film hardness, etc. In view of the hardness and adhesion of the plating film, it is preferable that C content is high. However, excessive addition of C leads to crack occurrence. In this experiment, cracks did not appear in the plating film of sample whose C content is 0.190 wt. %, but there is possibilities that such a C content leads to crack occurrence. Accordingly, it is preferable to keep a C content to a suitable range based on the use conditions of magnets. The recommended C contents are shown in the present claims 1 to 3.

From FIG. 4, it can be seen that the C content in the plating film can be controlled by adjusting the additive and current density used during plating deposition. Further, from FIGS. 4 to 6, it can be seen that plating film hardness increases as the plating film C content increases, and that adhesion also improves. For a Ni plating, a preferable C content is between 0.1 and 0.2 wt. %.

### EXAMPLE 2

In this example, Cu plating was examined in the same manner as the Example 1.

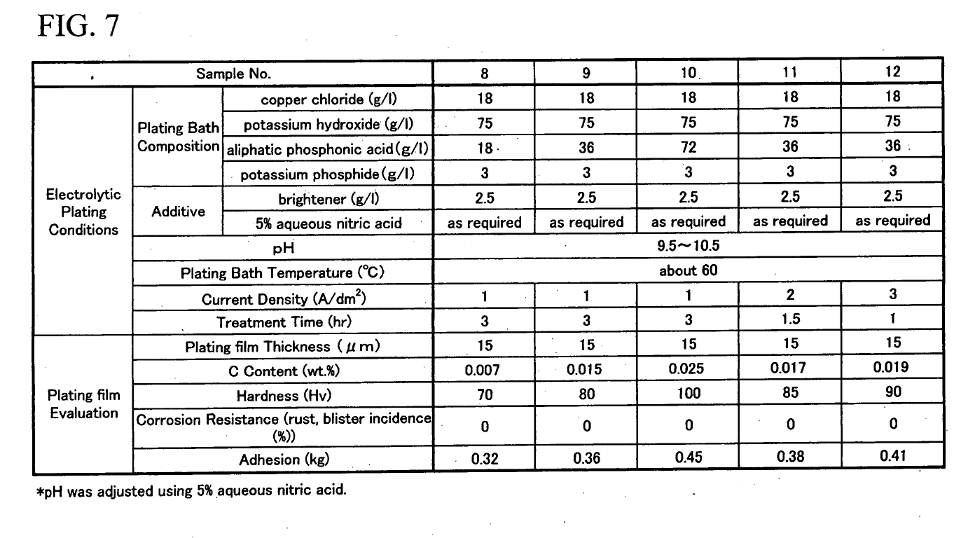

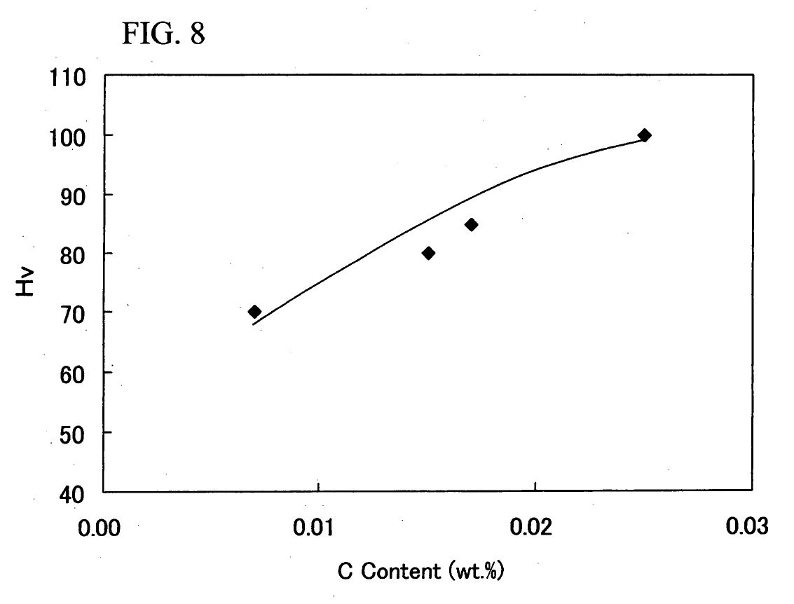

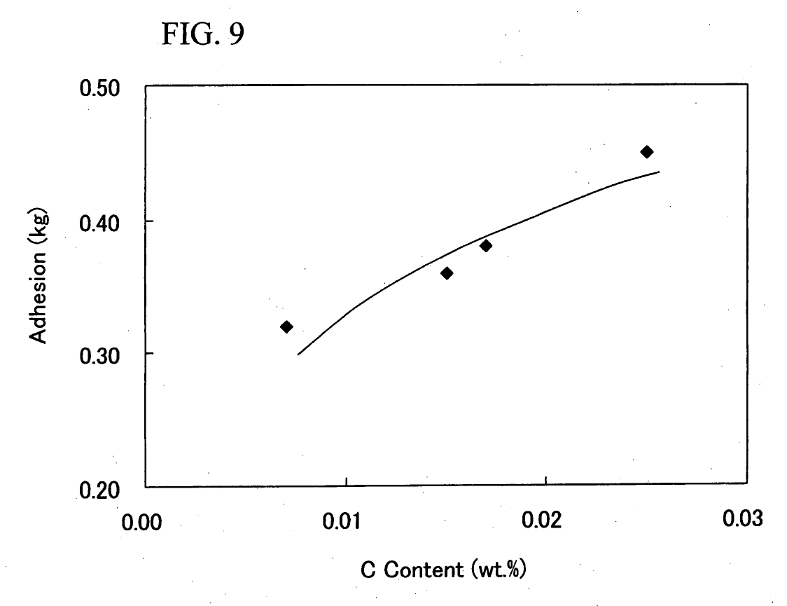

Using samples consisting of the same R—T—B system permanent magnet as in Example 1, plating films were formed under the conditions illustrated in FIG. 7. As shown in FIG. 7, sample Nos. 8 to 12 were prepared by varying the plating bath composition or current density. Once the plating films were formed, they were evaluated in the same manner as in Example 1. The results are shown in FIG. 7. Based on these results, the relationship between current density and C content, the relationship between C content and plating film hardness, and the relationship between C content and plating film adhesion were found. Those results are given in FIGS. 8 and 9.

From FIGS. 7 to 9, it was confirmed that plating film hardness increases as the plating film C content increases even for Cu plating, and that adhesion also improves. For a Cu plating, a preferable C content is between 0.006 and 0.05 wt. %.

### EXAMPLE 3

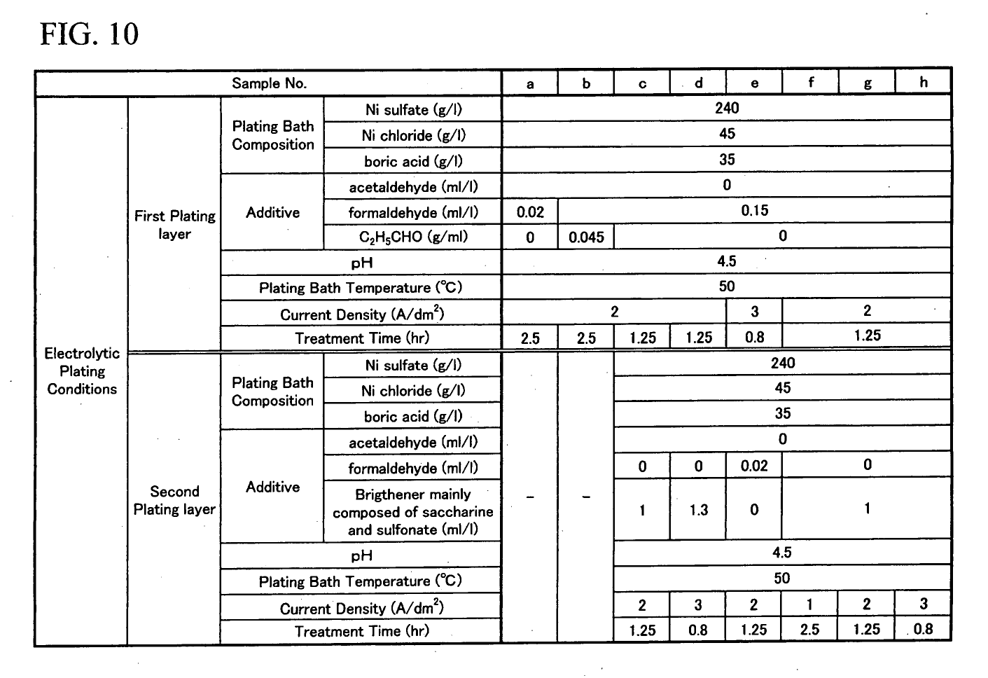

Using samples consisting of the same R—T—B system permanent magnet as in Example 1, Ni plating films were formed under the conditions illustrated in FIG. 10. Sample Nos. a and b were monolayer Ni plating, and sample Nos. c to h were multi-layer (bilayer) Ni plating. In addition, for sample Nos. c to e, the C content in the first plating layer and the second plating layer was varied by adjusting the deposition conditions of the first and second plating layers. Further, for sample Nos. f to h, the C content in the second plating layer was varied by adjusting the current density of the second plating layer.

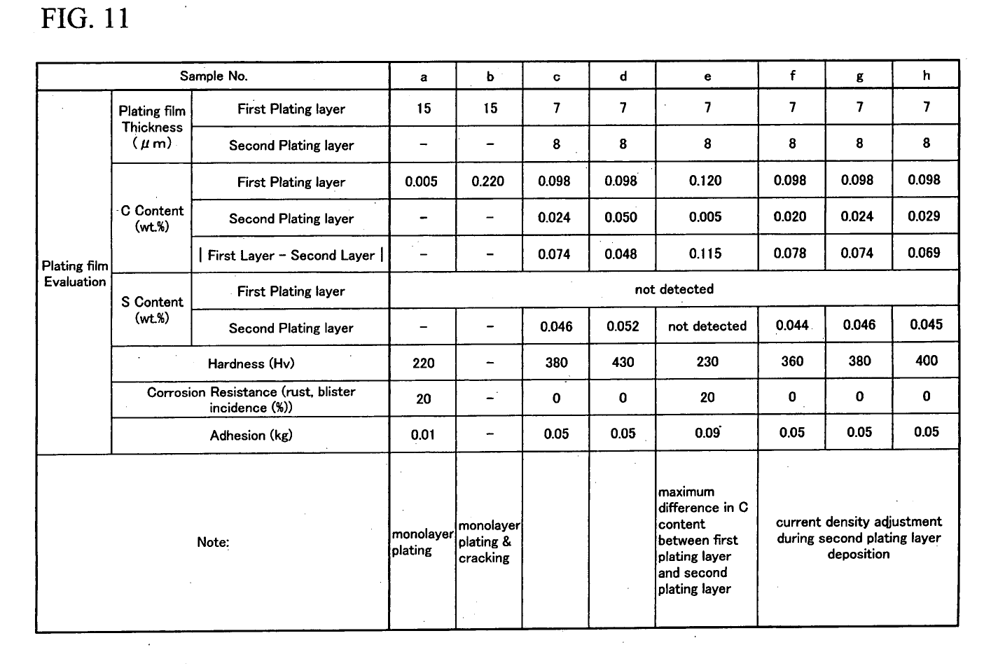

Once Ni plating had been completed, the formed plating films were evaluated in the same manner as in Example 1. Plating film composition analysis was carried out for sample Nos. c to h (bilayer plating) using monolayer samples whose first plating layer had been plated on a sample (magnet base body) consisting of a sintered body under the same conditions as the first plating layer and monolayer samples plated on a sample (magnet base body) consisting of a sintered body under the same conditions as the second plating layer. This was because for bilayers it is difficult to separate the first plating layer from the second plating layer for composition analysis. The evaluated results are shown in FIG. 11.

In FIG. 11, sample Nos. a and b are monolayer Ni plating. Sample No. a, which had a low C content of 0.005 wt. %, had poor corrosion resistance and plating film adhesion. On the other hand, cracks appeared in the plating film of sample No. b, which had a high C content of 0.220 wt. %. Sample No. b, in which cracks appeared, did not undergo hardness, corrosion resistance or adhesion evaluation.

For sample Nos. c to e, both their first plating layer and second plating layer had a C content within the range recommended by the present invention of 0.005 to 0.2 wt. %, and, their second plating layer had a lower C content than their first plating layer. However, in sample No. e, the difference in C content between the first and second plating layers (|first plating layer−second plating layer|) was large such as 0.115 wt. %. It is known that corrosion resistance deteriorates if the difference in C content between first and second plating layers is large like this, and hardness is low. A comparison of sample Nos. c and d shows that the smaller the difference in C content between first and second plating layers, or the larger the C content in the second plating layer, the harder the plating film.

Sample Nos. f to h were samples wherein the current density was adjusted during deposition of the second plating layer. It is learned that if the current density during deposition is increased that the C content contained in the plating layer increases. It is also learned that the smaller the difference in C content between first and second plating layers, or the larger the C content in the second plating layer, the more the hardness of the plating film improves.

### EXAMPLE 4

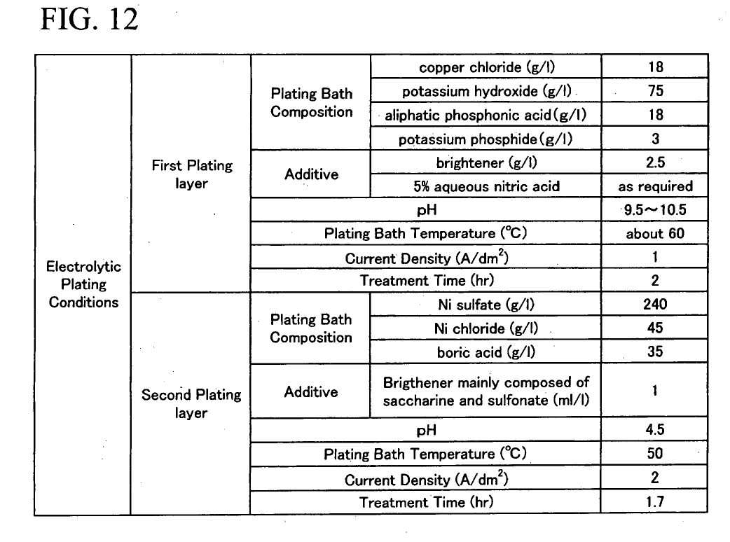

Using samples consisting of the same R—T—B system permanent magnet as in Example 1, first and second plating films were deposited under the conditions illustrated in FIG. 12. The first plating film is constituted of an electrolytic plating of Cu and the second plating film is constituted of an electrolytic plating of Ni.

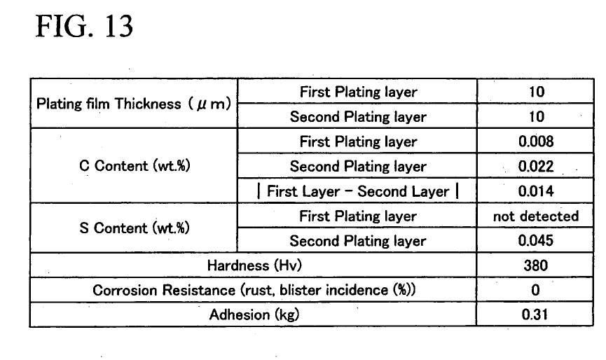

Once platings had been completed, the formed plating films were evaluated in the same manner as in Example 1. Plating film composition analysis was carried out using monolayer samples whose first plating layer had been plated on a sample (magnet base body) consisting of a sintered body under the same conditions as the first plating layer and monolayer samples plated on a sample (magnet base body) consisting of a sintered body under the same conditions as the second plating layer. This was because for bilayers it is difficult to separate the first plating layer from the second plating layer for composition analysis. The evaluated results are shown in FIG. 13.

As shown in FIG. 13, plating films with excellent corrosion resistance and high adhesion were formed. The hardness of the Ni plating as the second plating layer affected the hardness. The adhesion between the Cu plating as the first plating layer and the magnet base body affected the adhesion.

What is claimed is:

1. An R—T—B system permanent magnet comprising:
a magnet base body constituted from a sintered body which comprises at least main phase grains comprising an R₂T₁₄B compound, and a grain boundary phase which comprises a larger amount of R than the main phase grains; and
a plating film which covers the magnet base body surface and which comprises, when a C content is defined as Cc (wt. 0.005<Cc≦0.2 wt. %; wherein
R represents one or more rare earth element s , and T represents one or more transition metal elements comprising Fe, or Fe and Co as essential components.

2. The R—T—B system permanent magnet according to claim 1, wherein the C content Cc of the plating film is 0.006≦Cc≦0.18 wt. %.

3. The R—T—B system permanent magnet according to claim 1, wherein the C content Cc of the plating film is 0.007≦Cc≦0.15 wt. %.

4. The R—T—B system permanent magnet according to claim 1, wherein the plating film comprises an electrolytic plating layer of Ni or an electrolytic plating layer of Cu.

5. The R—T—B system permanent magnet according to claim 1, wherein the plating film comprises a first plating layer provided on the magnet base body surface side and a second plating layer provided on the first plating layer, wherein a difference in C content between the first plating layer and the second plating layer is 0.1 wt. % or less.

6. The R—T—B system permanent magnet according to claim 5, wherein the C content of the second plating layer is less than the C content of the first plating layer in a range of 0.1 wt. % or less.

7. The R—T—B system permanent magnet according to claim 5, wherein the first plating layer and the second plating layer are constituted from electrolytic plating of Ni and/or electrolytic plating of Cu.

8. A plating film, which covers over a substrate for corrosion resistance improvement, and which comprises 0.005<Cc≦0.2 wt. % when C content is defined as Cc (wt. %).

9. The plating film according to claim 8, wherein the C content Cc of the plating film is 0.006≦Cc≦0.18 wt. %.

10. The plating film according to claim 8, wherein the C content Cc of the plating film is 0.007≦Cc≦0.15 wt. %.

11. The plating film according to claim 8, wherein the plating film comprises an electrolytic plating layer of Ni or an electrolytic plating layer of Cu.

12. The plating film according to claim 8, wherein the plating film comprises a first plating layer provided on the substrate side and a second plating layer provided on the first plating layer,
in which a difference in C content between the first plating layer and the second plating layer is 0.1 wt. % or less.

13. The plating film according to claim 12, wherein the C content of the second plating layer is less than the C content of the first plating layer in a range of 0.1 wt. % or less.

14. The plating film according to claim 12, wherein the first plating layer and the second plating layer are constituted from electrolytic plating of Ni and/or electrolytic plating of Cu.
